(19) United States
(12) Patent Application Publication
(10) Pub. No.: US 2026/0075374 A1
(43) Pub. Date: Mar. 12, 2026

(54) PSEUDO-AMBISONICS SIGNAL GENERATING APPARATUS, PSEUDO-AMBISONICS SIGNAL GENERATING METHOD, ACOUSTIC EVENT PRESENTING SYSTEM, AND PROGRAM

(71) Applicant: NTT, Inc., Tokyo (JP)

(72) Inventors: Masahiro YASUDA, Musashino-shi, Tokyo (JP); Shoichiro SAITO, Musashino-shi, Tokyo (JP); Yusuke HIWASAKI, Musashino-shi, Tokyo (JP)

(73) Assignee: NTT, Inc., Tokyo (JP)

(21) Appl. No.: 19/106,220

(22) PCT Filed: Aug. 30, 2022
(86) PCT No.: PCT/JP2022/032478

§ 371 Date: Feb. 25, 2025

(51) Int. Cl. H04S 7/00; H04R 5/027

(52) U.S. Cl. CPC H04S 7/30; H04R 5/027; H04R 2201/401; H04S 2400/15; H04S 2420/11

(57) ABSTRACT

Make it possible to obtain a pseudo acoustic intensity vector using an acoustic signal collected by a wearable device. To this end, a pseudo-ambisonics signal generating apparatus according to the disclosed technology includes a spherical coordinate acquisition unit, a calculation unit, and a signal extraction unit. The spherical coordinate acquisition unit acquires spherical coordinates of each microphone with an intersection of a plane dividing a face symmetrically to the left and right and a straight line passing through the centers of left and right ears as an origin. The calculation unit calculates an average value of radii of the spherical coordinates, and replaces the radii of the spherical coordinates with the average values. The signal extraction unit generates a pseudo-ambisonics signal using the spherical coordinates replaced with the average values and acoustic signals acquired by the microphones.

### TECHNICAL FIELD

The disclosed technology relates to recording, analysis, and utilization of three-dimensional acoustic information.

### BACKGROUND ART

Being able to detect a type and an arrival direction of an acoustic event from an acoustic signal can be applied to various things.

For example, by linking a detection apparatus with a smart home appliance, it is possible to promptly notify a user of an abnormal situation in a house together with estimated event contents and position information.

Alternatively, by mounting a detection apparatus on a self-driving vehicle, it is possible to notify a driver of occurrence of danger and a necessary action.

In addition, alternatively, a pedestrian carrying a detection apparatus as a wearable apparatus can be notified of occurrence of danger and an accurate direction of the danger.

Such a technique is called sound event localization and detection (SELD).

In SELD, a microphone called a first order ambisonics (FOA) microphone is mainly used for measurement of a three-dimensional sound field. FIG. 1 schematically illustrates the FOA microphone. The FOA microphone is a microphone array in which unidirectional microphones M₁ to M₄ are disposed at four vertices of a regular tetrahedron.

Referring to Non-Patent Literature 1, spherical harmonic expansion of an acoustic signal and beamforming by an ambisonics signal will be outlined.

A sound pressure signal p having a wavenumber k observed in spherical coordinates (r, Ω) can be expanded as follows using spherical harmonics Yₗₘ.

$$\begin{matrix}[ Math . 1 ] & \\ p ( k , r , Ω ) = {\sum }_{l = 0}^{∞} {\sum }_{m = - l}^{l} {p}_{l m} ( k , r ) {Y}_{l m} ( Ω ) & ( 1 )\end{matrix}$$

Due to orthogonality of Yₗₘ, an expansion coefficient pₗₘ is typically calculated by the following formula.

$$\begin{matrix}[ Math . 2 ] & \\ {p}_{l m} ( k , r ) = {\int }_{0}^{2 π} {\int }_{0}^{π} p ( k , r , Ω ) {Y}_{l m}^{*} ( Ω ) sin θ d θ d ϕ & ( 2 )\end{matrix}$$

Coefficient information pₗₘ of the spherical harmonics obtained from an observation signal is called an ambisonics signal, and a case where l=0, 1 is used is called first-order ambisonics.

Since the obtained pₗₘ is an orthogonal basis, a beamformer that can generate an arbitrary beam pattern can be configured by weighting and adding them. In general, beamformer output y can be expressed as follows.

$$\begin{matrix}[ Math . 3 ] & \\ y ( k ) = {\sum }_{l = 0}^{N} {\sum }_{m = - l}^{l} {w}_{l m}^{*} ( k ) {p}_{l m} ( k ) & ( 3 )\end{matrix}$$

In a case where a sound source is in a sufficiently far-field and the observation signal can be regarded as a plane wave, a weight wₗₘ for obtaining a beam pattern in a Ωᵤ direction can be configured as follows.

$$\begin{matrix}[ Math . 4 ] & \\ {w}_{l m}^{*} ( k , {Ω}_{u} ) = \frac{1}{{b}_{l} ( k )} {Y}_{l m} ( {Ω}_{u} ) & ( 4 )\end{matrix}$$

Here, bₗ(k) is a coefficient depending on a baffle structure of a microphone.

From Formulas (3) and (4), beamformer output having directivity in the Qu direction is expressed as follows.

$$\begin{matrix}[ Math . 5 ] & \\ y ( k , {Ω}_{u} ) = {{\sum }_{l = 0}}^{N} {{\sum }_{m = - l}}^{l} \frac{1}{{b}_{l} ( k )} {Y}_{l m} ( {Ω}_{u} ) {p}_{l m} ( k ) & ( 5 )\end{matrix}$$

Here, in order to obtain y(k, Ωᵤ) of (5) from signal sounds actually observed by q microphones on a rigid sphere with a radius r, approximation of pₗₘ as the following formula is used.

$$\begin{matrix}[ Math . 6 ] & \\ {p}_{l m} ( k ) \approx {\sum }_{{q = 1}^{}}^{M} {Y}_{l m}^{*} ( {Ω}_{q} ) p ( k , {r}_{q} , {Ω}_{q} ) & ( 6 )\end{matrix}$$

By substituting Formula (6) into Formula (5), Formula (7) is obtained.

$$\begin{matrix}[ Math . 7 ] & \\ y ( k , {Ω}_{u} ) \approx {\sum }_{l = 0}^{N} \frac{1}{{b}_{l} ( k )} {\sum }_{m = - l}^{l} {Y}_{l m} ( {Ω}_{u} ) \cdot {\sum }_{q = 1}^{M} {Y}_{l m}^{*} ( {Ω}_{q} ) p ( k , {r}_{q} , {Ω}_{q} ) & ( 7 )\end{matrix}$$

A direction Ωᵤ in which a signal intensity of Formula (7) is maximized is namely a signal arrival direction.

However, in order to obtain the signal arrival direction using Formula (7), it is necessary to calculate signal intensities in all directions, which is not easy. Therefore, Non-Patent Literature 1 proposes a method for estimating a direction of a sound source by approximately deriving a physical quantity called an acoustic intensity vector representing a propagation direction and an intensity of sound from an ambisonics signal by using a case of first-order ambisonics as an example.

An acoustic intensity vector I is defined by the following formula with a sound pressure as p and a particle velocity vector as v.

$$\begin{matrix}[ Math . 8 ] & \\ I = \frac{1}{2} R e \{ {p}^{*} \cdot v \} & ( 8 )\end{matrix}$$

Replacing p with a 0th-order component of spherical harmonics obtained from an observation acoustic signal, replacing v with a first-order component, a pseudo acoustic intensity vector with the wavenumber k is defined as follows.

$$\begin{matrix}[ Math . 9 ] & \\ I ( k ) = \frac{1}{2} R e \{ {p}_{00}^{*} ( k ) [ \begin{matrix}{p}_{x} ( k ) \\ {p}_{y} ( k ) \\ {p}_{z} ( k )\end{matrix} ] \} & ( 9 )\end{matrix}$$

Here, pₓ(k), p_{y}(k), and p_{z}(k) are given as follows.

$$\begin{matrix}[ Math . 10 ] & \\ {p}_{x} ( k ) \approx {p}_{1 ( - 1 )} ( k ) {Y}_{1 ( - 1 )} ( \frac{π}{2} , 0 ) + {p}_{10} ( k ) {Y}_{10} ( \frac{π}{2} , 0 ) + {p}_{11} ( k ) {Y}_{11} ( \frac{π}{2} , 0 ) & ( 10 )\end{matrix}$$

$$\begin{matrix}[ Math . 11 ] & \\ {p}_{y} ( k ) \approx {p}_{1 ( - 1 )} ( k ) {Y}_{1 ( - 1 )} ( \frac{π}{2} , \frac{π}{2} ) + {p}_{10} ( k ) {Y}_{10} ( \frac{π}{2} , \frac{π}{2} ) + {p}_{11} ( k ) {Y}_{11} ( \frac{π}{2} , \frac{π}{2} ) & ( 11 )\end{matrix}$$

$$\begin{matrix}[ Math . 12 ] & \\ {p}_{z} ( k ) \approx {p}_{1 ( - 1 )} ( k ) {Y}_{1 ( - 1 )} ( 0 , 0 ) + {p}_{10} ( k ) {Y}_{10} ( 0 , 0 ) + {p}_{11} ( k ) {Y}_{11} ( 0 , 0 ) & ( 12 )\end{matrix}$$

Many SELD apparatuses improve estimation accuracy of a sound source direction by using this pseudo acoustic intensity vector as an input feature.

By increasing the number of microphones and increasing the amount of information obtained from an observed three-dimensional sound field, expansion using higher-order spherical harmonics becomes possible.

Since N-th-order spherical harmonics have 2N+1 components, at least Σₘ₌₀^{N}(2m+1)=(N+1)² microphones are required to obtain expansion coefficients up to the N-th order.

A pseudo acoustic intensity vector in an N-th order ambisonics signal can be obtained by calculating a particle velocity vector of the pseudo acoustic intensity vector of Non-Patent Literature 1 with first to N-th order components.

Hereinafter, the ambisonics signal means an N-th order ambisonics signal that is not limited to the first order.

### PRIOR ART LITERATURE

### Non-Patent Literature

Non-Patent Literature 1: D. P. Jarrett et al., “3D SOURCE LOCALIZATION IN THE SPHERICAL HARMONIC DOMAIN USING PSEUDOINTENSITY VECTOR”, 18th European Signal Processing Conference (EUSIPCO 2010) Proceedings, pp. 442-446

### SUMMARY OF THE INVENTION

### Problems to be Solved by the Invention

For example, it is not realistic for a pedestrian to carry a FOA microphone including a total of four microphones disposed at vertices of a regular tetrahedron on a daily basis, and improvement is required.

Wearable microphones are easy for humans to carry, but are difficult to dispose them on the same spherical surface. Ifan array of microphones is disposed on a spherical surface having a radius R, an ambisonics signal can be calculated by directly using spherical coordinates (R, φ_{q}, θ_{q}) of respective microphones calculated with the center of the sphere as an origin. However, in a case where a large number of microphones are disposed on a head, a spherical surface passing through all the microphone positions is not typically defined.

When the microphones are not disposed on the same spherical surface, collected acoustic signals cannot be converted into an ambisonics signal. A signal in ambisonics format is required to derive a pseudo acoustic intensity vector used as an input feature for SELD.

An object of the disclosed technology is to obtain a pseudo acoustic intensity vector by using an acoustic signal collected by an apparatus (wearable apparatus) mounted on a human.

### Means to Solve the Problems

In order to achieve the above object, a pseudo-ambisonics signal generating apparatus according to the disclosed technology includes a spherical coordinate acquisition unit, a calculation unit, and a signal extraction unit.

The spherical coordinate acquisition unit acquires spherical coordinates of each microphone with an intersection of a plane dividing a face symmetrically to the left and right and a straight line passing through the centers of left and right ears as an origin.

The calculation unit calculates an average value of radii of the spherical coordinates, and replaces the radii of the spherical coordinates with the average values.

The signal extraction unit generates a pseudo-ambisonics signal using the spherical coordinates replaced with the average values and acoustic signals acquired by the microphones.

In addition, an acoustic event presenting system according to the disclosed technology includes at least four microphones disposed on a head of a human body, a pseudo-ambisonics signal generating apparatus, an estimation apparatus, and a presenting apparatus.

The pseudo-ambisonics signal generating apparatus generates a pseudo-ambisonics signal from acoustic signals acquired by the microphones.

The estimation apparatus estimates a direction and a type of a sound source from the pseudo-ambisonics signal.

The presenting apparatus presents information on the sound source to a user according to the estimation result.

### Effects of the Invention

According to the disclosed technology, a pseudo acoustic intensity vector can be obtained using an acoustic signal collected by an apparatus (wearable apparatus) mounted on a human, and a wearable pseudo-ambisonics signal generating apparatus and an acoustic event presenting system can be achieved.

### BRIEF DESCRIPTION OF THE DRAWINGS

FIG. 1 a drawing for describing SELD according to a conventional technique.

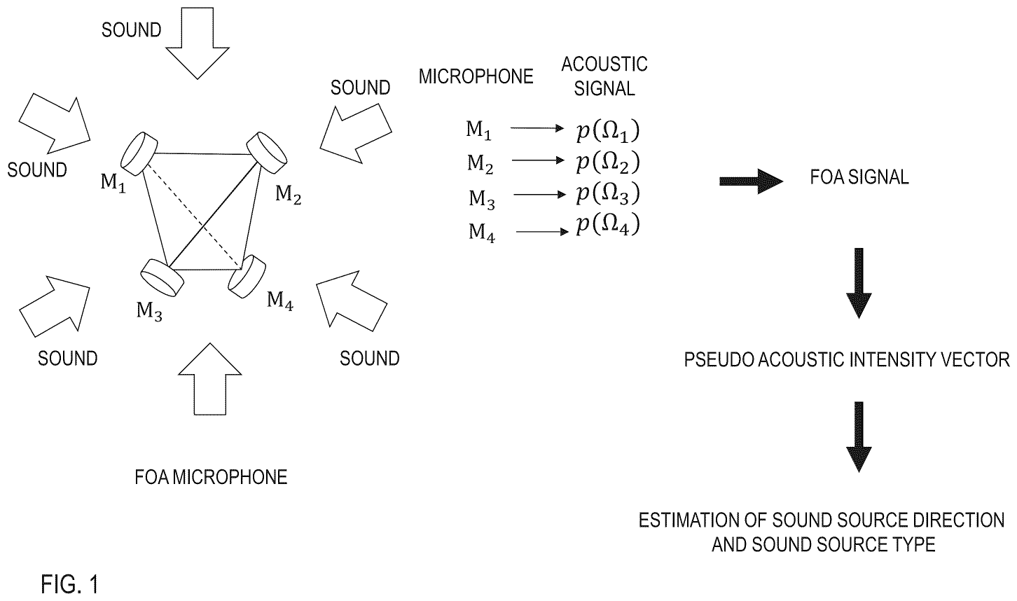

FIG. 2 a functional block diagram of an acoustic event presentation system including a pseudo-ambisonics signal generating apparatus according to a first embodiment.

FIG. 3 a drawing illustrating an example of spherical coordinates set on a head of a human body.

FIG. 4 a flowchart for describing an operation of the pseudo-ambisonics signal generating apparatus.

FIG. 5 a flowchart for describing an operation of an estimation apparatus.

FIG. 6 a functional block diagram of a sound presenting apparatus.

FIG. 7 a flowchart for describing an operation of the sound presenting apparatus.

FIG. 8 a functional block diagram of a video presenting apparatus.

FIG. 9 a flowchart for describing an operation of the video presenting apparatus.

FIG. 10 a diagram illustrating a functional configuration example of a computer.

### DETAILED DESCRIPTION OF THE EMBODIMENTS

Hereinafter, embodiments of the disclosed technology will be described in detail. Note that components having the same functions are denoted by the same reference numerals, and redundant description will be omitted.

### First Embodiment

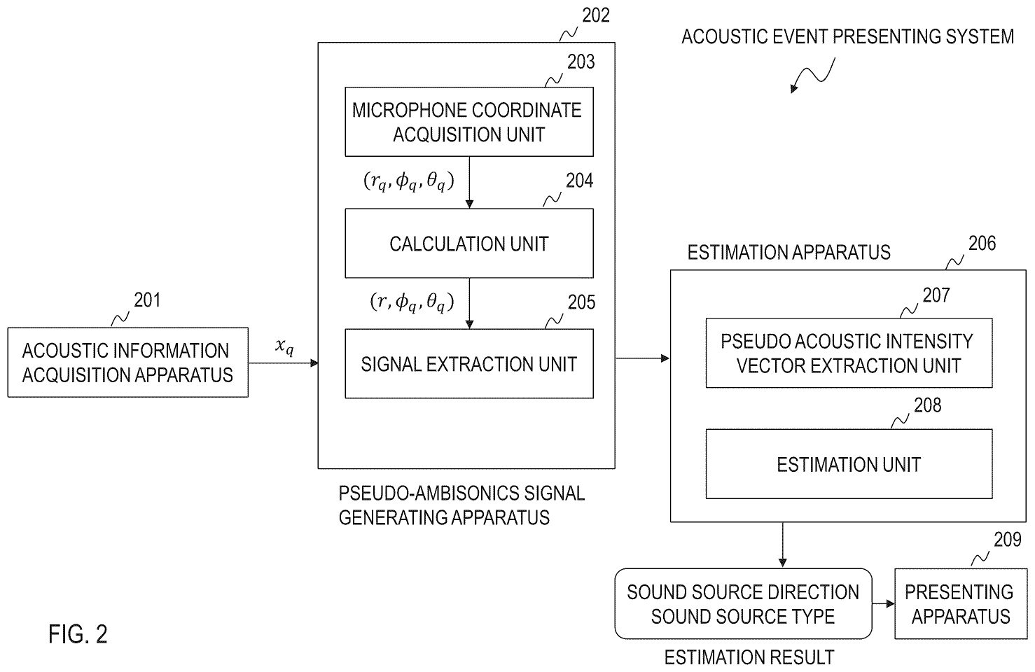

FIG. 2 illustrates a functional block diagram of an example of an acoustic event presenting system including a pseudo-ambisonics signal generating apparatus according to the disclosed technology.

The acoustic event presenting system includes an acoustic information acquisition apparatus 201, a pseudo-ambisonics signal generating apparatus 202, an estimation apparatus 206, and a presenting apparatus 209.

### <Acoustic Information Acquisition Apparatus>

The acoustic information acquisition apparatus 201 acquires Q-channel acoustic signals x_{q} obtained from Q microphones installed at arbitrary positions on a head or an apparatus worn on the head, and supplies the Q-channel acoustic signals x_{q} to the pseudo-ambisonics signal generating apparatus 202. Note that Q is an integer of 4 or greater.

### <Pseudo-Ambisonics Signal Generating Apparatus>

The pseudo-ambisonics signal generating apparatus 202 includes a microphone coordinate acquisition unit 203, a calculation unit 204, and a signal extraction unit 205.

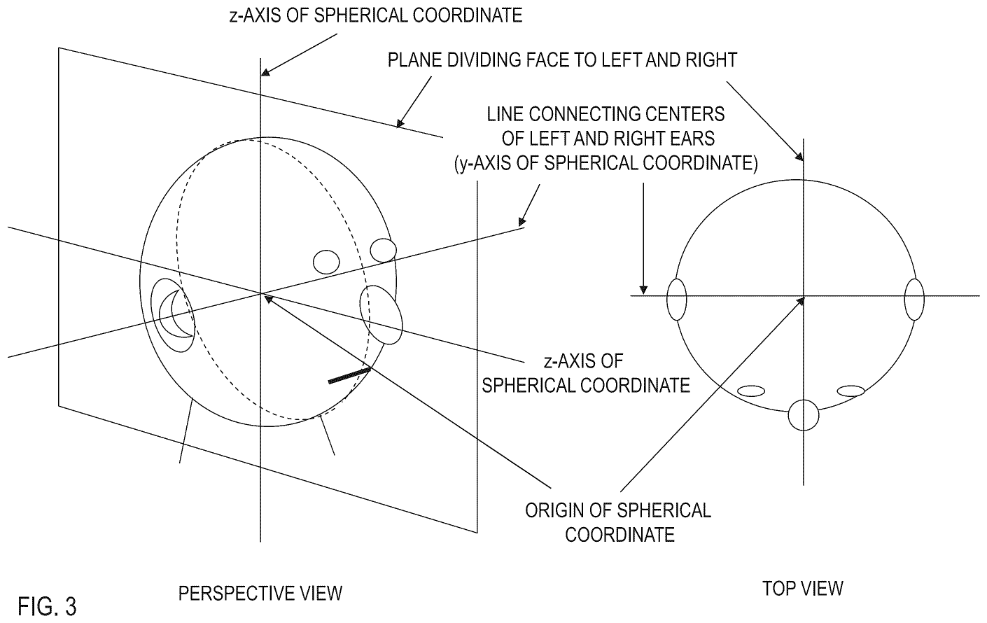

FIG. 3 illustrates an example of a spherical coordinate system for calculating microphone coordinates. In settings of the following spherical coordinate system, settings of an x-axis, a y-axis, and a z-axis passing through an origin are merely an example, and the settings are not limited thereto.

A line passing through the centers of left and right ears is defined as the y-axis. An intersection of a plane dividing a face symmetrically to the left and right and the y-axis is defined as the origin of the spherical coordinate system. A straight line passing through the origin in a vertical direction of the head and perpendicular to the y-axis is defined as the z-axis of the spherical coordinate system. A straight line passing through the origin in a front-back direction of the head and perpendicular to the y-axis is defined as the x-axis of the spherical coordinate system. In addition, an azimuth of the spherical coordinate system is φ, and an elevation is θ.

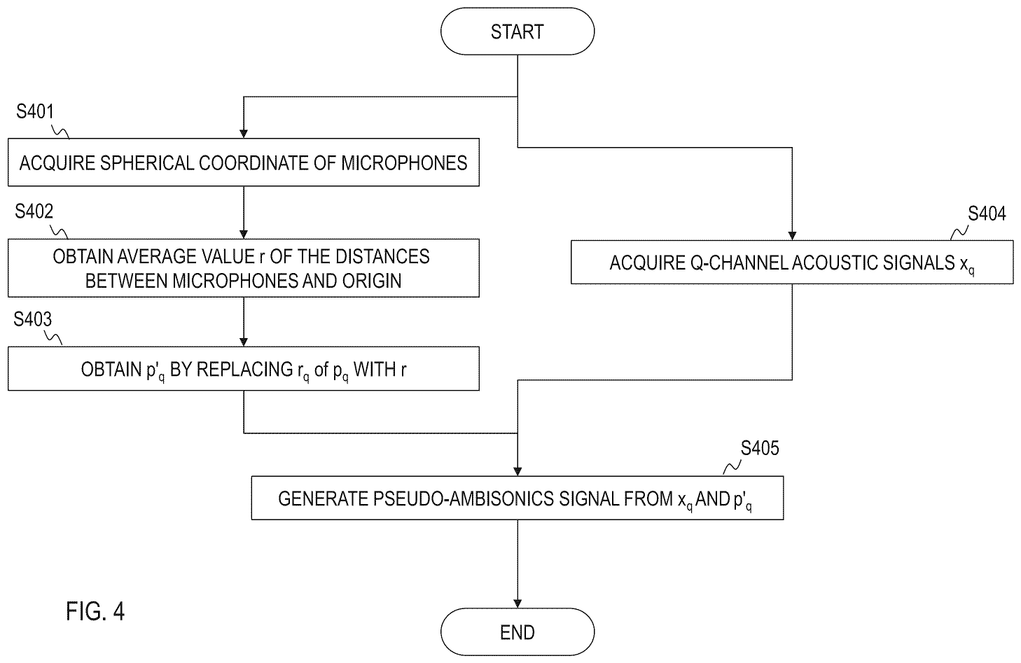

FIG. 4 is a flowchart for describing an operation of the pseudo-ambisonics signal generating apparatus.

The microphone coordinate acquisition unit 203 acquires spherical coordinates p_{q}=(r_{q}, φ_{q}, θ_{q}) (q=1, 2, . . . , Q) of the respective microphones based on the coordinate system in FIG. 3 (step S401). For p_{q}, a value measured by an apparatus outside the pseudo-ambisonics signal generating apparatus 202 may be acquired, or a value stored in the pseudo-ambisonics signal generating apparatus 202 as setting information may be read.

The calculation unit 204 corrects the spherical coordinates acquired by the microphone coordinate acquisition unit.

In the case of a FOA microphone (more generally, in the case of a microphone array disposed on a spherical surface having a radius R), an ambisonics signal can be calculated by directly using the spherical coordinates (R, φ_{q}, θ_{q}) of the respective microphones calculated with the center of the sphere as the origin. However, in the case of the microphones disposed on the head, distances between the origin defined above and the respective microphones are typically not equal, and the microphone coordinates cannot be directly used for calculating an ambisonics signal. Therefore, in the first embodiment, an average value r of the distances between the respective microphones and the origin is obtained (step S402), and p′q=(r, φ_{q}, θ_{q}) obtained by replacing each r_{q} of p_{q} with r is set as approximate spherical coordinates of the corresponding microphone (step S403).

Next, the pseudo-ambisonics signal generating apparatus 202 acquires the Q-channel acoustic signals x_{q} from the acoustic information acquisition apparatus 201 (step S404), and generates a pseudo-ambisonics signal using Q sets of p′_{q} and x_{q} (step S405). That is, the pseudo-ambisonics signal generating apparatus 202 generates the pseudo-ambisonics signal by signal processing (spherical harmonic expansion or the like) for a case where Q-channel microphones are disposed on a rigid sphere having a radius r.

### <Estimation Apparatus>

The estimation apparatus 206 includes a pseudo acoustic intensity vector extraction unit 207 and an estimation unit 208, and receives the pseudo-ambisonics signal as input and outputs an estimation result of a direction and a type of a sound source.

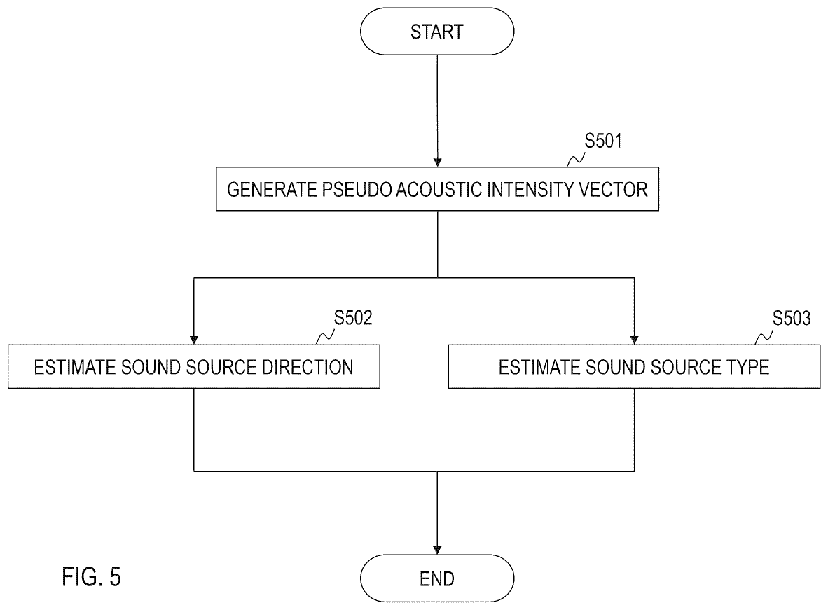

FIG. 5 is a flowchart for describing an operation of the estimation apparatus 206.

The pseudo acoustic intensity vector extraction unit 207 generates a pseudo acoustic intensity vector from the pseudo-ambisonics signal by, for example, the method described in Non-Patent Literature 1 (step S501).

The estimation unit 208 estimates the arrival direction of the sound source (step S502) and the type of the sound source (step S503) using the pseudo acoustic intensity vector and the pseudo-ambisonics signal.

For the estimation, for example, a deep neural network (DNN) similar to that described in “A. Politis et. al, “A dataset of dynamic reverberant sound scenes with directional interferers for sound event localization and detection”, arXiv: 2106.06999, 2021” (Reference Literature 1) obtained by learning an acoustic feature extracted by the present invention as input may be used. The DNN may be configured to receive the pseudo acoustic intensity vector and the pseudo-ambisonics signal as input, and output, as the estimation result, for example, a three-dimensional unit vector as the sound source direction and an integer corresponding to a label such as “bell sound” or “car traveling sound” as the sound source type.

### <Presenting Apparatus>

The presenting apparatus 209 converts the estimation result into acoustic or visual information and provides a user with the information.

### First Presentation Example

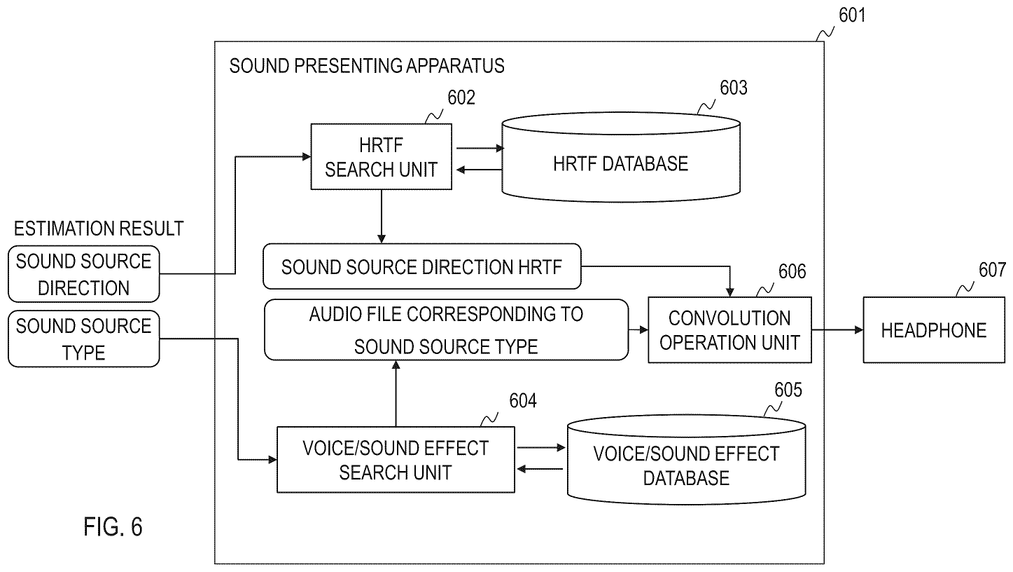

In a first presentation example, the estimation result is converted into stereophonic sound and presented to the user. FIG. 6 illustrates a functional block diagram of a sound presenting apparatus 601 according to the first presentation example.

The sound presenting apparatus 601 includes an HRTF search unit 602, an HRTF database 603, a voice/sound effect search unit 604, a voice/sound effect database 605, and a convolution operation unit 606.

Note that the HRTF is an acronym of head related transfer function, and is a function representing how sound reaches from a sound source to both ears. In the HRTF database, HRTFs covering all directions of a sphere centered on a head or HRTFs covering all directions of an upper hemisphere, and the like are registered in advance according to applications of the acoustic event presenting system.

In the voice/sound effect database, voices or sound effects corresponding to the sound source types (audio-files-corresponding-to-sound-source-types) obtained as the estimation results are registered. A correspondence between the sound source type of the estimation result and the audio-file-corresponding-to-sound-source-type may be determined by any method. For example, as the audio-file-corresponding-to-sound-source-type to the sound source type “car”, a file recording a warning voice of “a car is approaching” or the like can be used.

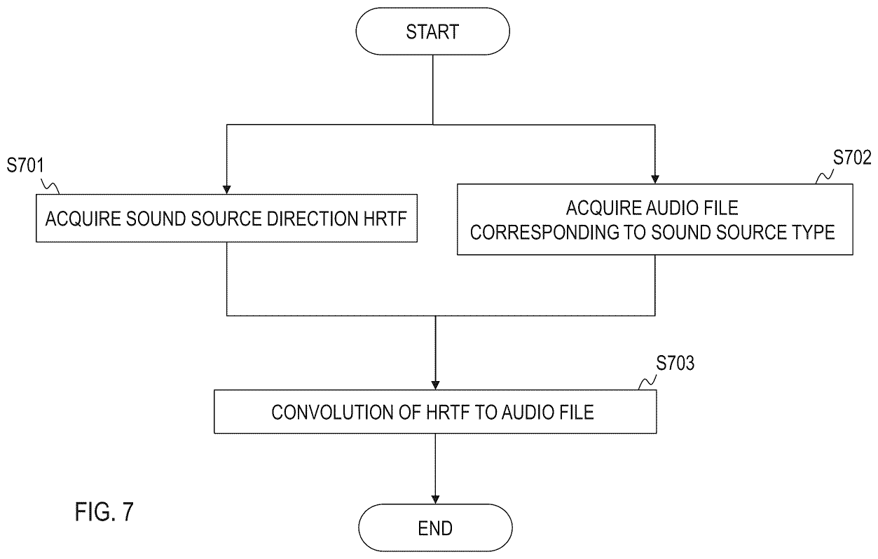

FIG. 7 is a flowchart for describing an operation of the sound presenting apparatus 601.

The HRTF search unit 602 searches the HRTF database for an HRTF in a direction closest to the sound source direction obtained as the estimation result to obtain the sound source direction HRTF (step S701).

The voice/sound effect search unit 604 searches the voice/sound effect database for a voice or a sound effect corresponding to the sound source type obtained as the estimation result to obtain the audio-file-corresponding-to-sound-source-type (step S702).

The convolution operation unit 606 operate convolution of the sound source direction HRTF to the obtained audio-file-corresponding-to-sound-source-type (step S703). As a result, sound is generated that assumes a situation in which the audio-file-corresponding-to-sound-source-type is reproduced in the sound source direction. For example, it is possible to present, to the user, stereophonic sound in which a voice such as “a car is approaching” is heard from the arrival direction of the car.

### Second Presentation Example

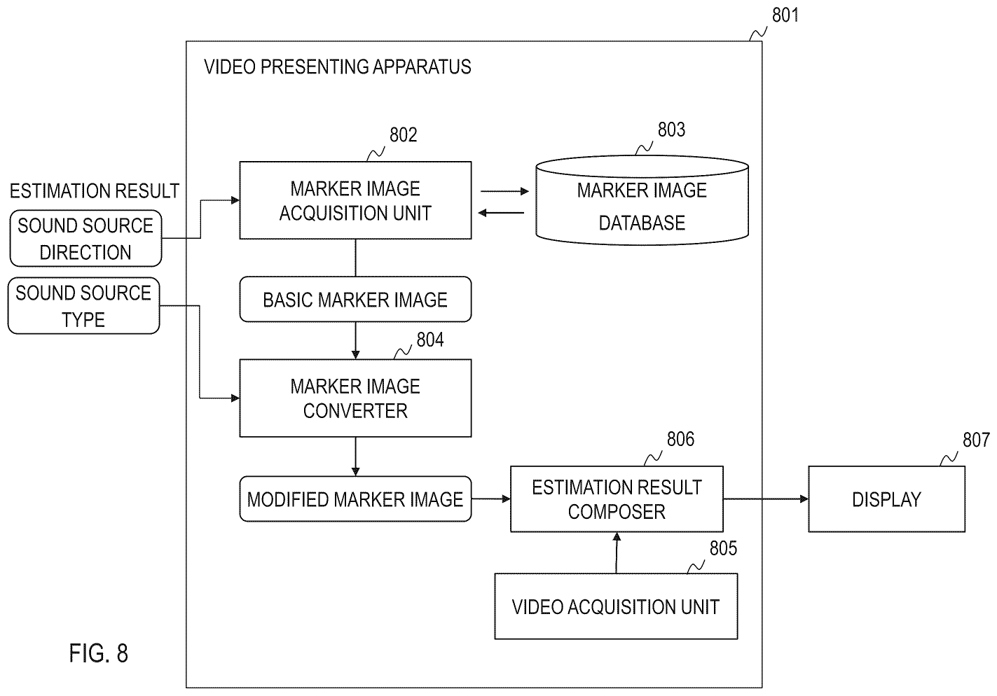

In a second presentation example, the estimation result is converted into video and presented to the user. FIG. 8 illustrates a functional block diagram of a video presenting apparatus 801 according to the second presentation example.

The video presenting apparatus 801 includes a marker image acquisition unit 802, a marker image database 803, a marker image converter 804, a video acquisition unit 805, and an estimation result composer 806.

In the marker image database 803, for example, a stereoscopic arrow image having a shape or a color according to the type of the sound source is registered as a basic marker image.

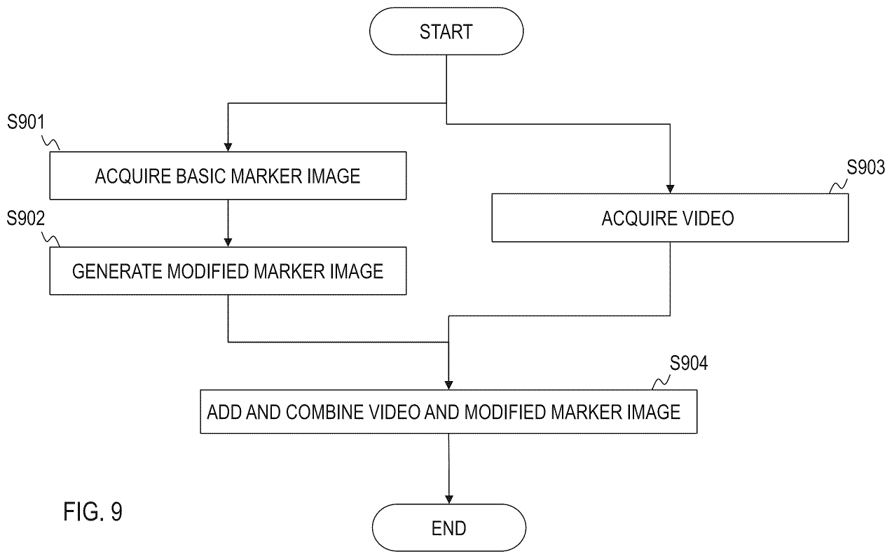

FIG. 9 is a flowchart for describing an operation of the video presenting apparatus 801.

The marker image acquisition unit 802 acquires the basic marker image according to the type of the sound source from the marker image database 803 (step S901).

The marker image converter 804 stereoscopically rotates the basic marker image using the sound source direction of the estimation result to generate a modified marker image (step S902). For example, the basic marker image is rotated so as to indicate that the marker image extends in the sound source direction from the center of the head.

The video acquisition unit 805 acquires a video around the user (step S903).

The estimation result composer 806 adds and combines the video acquired by the video acquisition unit 805 and the modified marker image (step S904).

As a result, the video presenting apparatus 801 can visually present the type and the arrival direction of the sound source to the user.

Note that marker images for all sound source directions/types may be registered in advance in the marker image database, and the marker image may be selected according to the sound source type and direction.

Alternatively, the basic marker image may be generated according to the sound source type, and the direction of the marker image may be determined on the basis of the sound source direction.

### [Modification]

In the first embodiment, the approximate center (the intersection of the line passing through the centers of the left and right ears and the plane dividing the face symmetrically to the left and right) of the head is set as the origin of the spherical coordinates. However, in a case where there are four microphones worn on the head, a spherical surface passing through all the microphones may be calculated, and the center of the sphere may be set as the origin.

### [Program and Recording Medium]

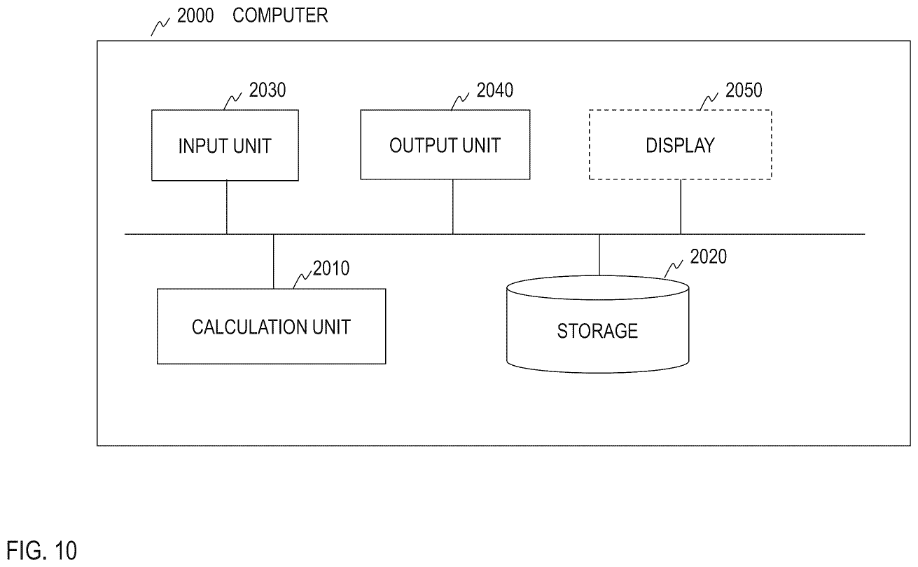

The various processes described above can be performed by causing a storage 2020 of a computer 2000 illustrated in FIG. 10 to read a program for executing each step of the method described above and causing a calculation unit 2010, an input unit 2030, an output unit 2040, a display unit 2050, and the like to operate.

The program in which the processing contents are described can be recorded on a computer-readable recording medium. The computer-readable recording medium may be, for example, any recording medium such as a magnetic recording device, an optical disc, a magneto-optical recording medium, or a semiconductor memory.

In addition, the program is distributed by, for example, selling, transferring, or renting a portable recording medium such as a DVD or CD-ROM in which the program is recorded. Further, the program may be stored in a storage of a server computer and be distributed by transferring the program from the server computer to another computer via a network.

For example, a computer that executes such a program first temporarily stores a program recorded on a portable recording medium or a program transferred from a server computer in a storage of its own. Then, when executing processing, the computer reads the program stored in the storage of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program described herein includes information that is used for processing by an electronic computing machine and is equivalent to the program (data or the like that is not a direct command to the computer but has a property that defines processing of the computer).

In addition, in the description above, although the apparatus according to the disclosed technology is configured by the predetermined program being executed on the computer, at least a part of the processing contents may be implemented by hardware.

1. A pseudo-ambisonics signal generating apparatus that generates an ambisonics signal from acoustic signals acquired by at least four microphones disposed on a head of a human body, the apparatus comprising:
a spherical coordinate acquisition circuitry that acquires spherical coordinates of each microphone with an intersection of a plane dividing a face symmetrically to left and right and a straight line passing through centers of left and right ears as an origin;
a calculation circuitry that calculates an average value of radii of the spherical coordinates and replaces the radii of the spherical coordinates with the average values; and
a signal extraction circuitry that generates a pseudo-ambisonics signal using the spherical coordinates replaced with the average values and the acoustic signals acquired by the microphones.

2. A pseudo-ambisonics signal generating method for generating an ambisonics signal from acoustic signals acquired by at least four microphones disposed on a head of a human body, the method comprising:
a step of acquiring, by a coordinate acquisition circuitry, spherical coordinates of each microphone with an intersection of a plane dividing a face symmetrically to left and right and a straight line passing through centers of left and right ears as an origin;
a step of calculating, by a calculation circuitry, an average value of radii of the spherical coordinates and replacing the radii of the spherical coordinates with the average values; and
a step of generating, by a signal extraction circuitry, a pseudo-ambisonics signal using the spherical coordinates replaced with the average values and the acoustic signals acquired by the microphones.

3. An acoustic event presenting system comprising:
at least four microphones disposed on a head of a human body:
a pseudo-ambisonics signal generating apparatus that generates a pseudo-ambisonics signal from acoustic signals acquired by the microphones:
an estimation apparatus that estimates a direction and a type of a sound source from the pseudo-ambisonics signal; and
a presenting apparatus that presents information on the sound source to a user according to the estimated direction and type of the sound source.

4. The acoustic event presenting system according to claim 3, wherein
the presenting apparatus acoustically or visually presents the direction and the type of the sound source.

5. A non-transitory computer-readable recording medium which stores program for causing a computer to function as the pseudo-ambisonics signal generating apparatus according to claim 1.
